(19) United States
(12) Patent Application Publication
(10) Pub. No.: US 2026/0103848 A1
(43) Pub. Date: Apr. 16, 2026

(54) MOULDING SYSTEM

(71) Applicant: Pulpex Limited, Sawston (GB)

(72) Inventors: Adam Richard TURNER, Croydon (GB); Daniel George PROZESKY, Sawston (GB); Theo Richard ASHCROFT, Sawston (GB)

(21) Appl. No.: 19/418,796

(22) Filed: Dec. 12, 2025

Related U.S. Application Data
(63) Continuation of application No. PCT/GB2024/051616, filed on Jun. 25, 2024.

(30) Foreign Application Priority Data
Jun. 29, 2023 (GB) 2309878.3

(51) Int. Cl. D21J 3/10; B29C 31/00; B29C 44/12

(52) U.S. Cl. CPC D21J 3/10; B29C 31/008; B29C 44/12

(57) ABSTRACT

Disclosed is a moulding system for providing a hollow moulded fibre product, the moulding system comprising: a first mould defining a first mould cavity and having a first mould body portion wall having a first mould length, the first mould configured to provide a hollow moulded fibre product precursor having a precursor body having a first body length in a longitudinal direction of the hollow moulded fibre product precursor; and a second mould defining a second mould cavity and having a second mould body portion wall having a second mould length greater than the first mould length, the second mould configured to provide the hollow moulded fibre product; wherein the moulding system is configured, with the hollow moulded fibre product precursor in the second mould cavity, to stretch the precursor body of the hollow moulded fibre product precursor from the first body length to a second body length, the second body length equal to the second mould length, to thereby provide the hollow moulded fibre product from the hollow moulded fibre product precursor.

### CROSS-REFERENCE TO RELATED APPLICATIONS

This application is a continuation under 35 U.S.C. § 120 of International Application No. PCT/GB2024/051616, filed Jun. 25, 2024, which claims priority to United Kingdom Application No. GB 2309878.3, filed Jun. 29, 2023, under 35 U.S.C. § 119(a). Each of the above-referenced patent applications is incorporated by reference in its entirety.

### TECHNICAL FIELD

The present invention relates to methods and systems for manufacturing receptacles from a fibre suspension, such as a fibre suspension comprising paper pulp. The receptacles may be consumer packaging, such as bottles, jars or certain types of vases, useful for holding liquids, powders, other flowable materials, one or more solid objects, or a combination thereof.

### BACKGROUND

It is desirable to reduce glass and plastics use in consumable items, particularly packaging. Non-necked receptacles, such as trays, bowls and other simple shapes, are commonly made from paper pulp. However, a more complex necked receptacle, like a bottle, jar or certain types of vase, is more difficult to engineer due to an internal narrowing of the receptacle between a main body portion of the receptacle and an opening of the receptacle.

At certain stages, particularly early stages, during formation of a hollow moulded fibre product, the hollow moulded fibre product may be relatively fragile. The hollow moulded fibre product may thus be easily damaged by impacts, for example during handling of the hollow moulded fibre product.

### SUMMARY

According to a first aspect of the present invention, there is provided a moulding system for providing a hollow moulded fibre product, the moulding system comprising: a first mould defining a first mould cavity and having a first mould body portion wall having a first mould length, the first mould configured to provide a hollow moulded fibre product precursor having a precursor body having a first body length in a longitudinal direction of the hollow moulded fibre product precursor; and a second mould defining a second mould cavity and having a second mould body portion wall having a second mould length greater than the first mould length, the second mould configured to provide the hollow moulded fibre product; wherein the moulding system is configured, with the hollow moulded fibre product precursor in the second mould cavity, to stretch the precursor body of the hollow moulded fibre product precursor from the first body length to a second body length, the second body length equal to the second mould length, to thereby provide the hollow moulded fibre product from the hollow moulded fibre product precursor.

At certain stages, particularly early stages, during formation of a hollow moulded fibre product, the hollow moulded fibre product may be relatively fragile. The hollow moulded fibre product, and/or its precursor, may thus be easily damaged by impacts, for example during handling of the hollow moulded fibre product.

In use of the moulding system, the hollow moulded fibre product precursor is formed by moulding in the first mould and has a precursor body having the first body length. The hollow moulded fibre product precursor is subsequently transferred to the second mould. Since the second mould has the second mould body portion wall having the second mould length, which is greater than the first mould length and thus greater than the first body length, clearance is provided between the precursor body and the second mould when the hollow moulded fibre product precursor is in the second mould cavity. The precursor body is then stretched in the second mould to a desired length, the second body length, to provide the hollow moulded fibre product. Accordingly, due to the clearance between the precursor body and the second mould when the hollow moulded fibre product precursor is in the second mould cavity, chance of damage being imparted to the hollow moulded fibre product precursor during its transfer to the second mould may be reduced compared with a moulding system in which the second mould length is equal to the first body length, whilst still obtaining a hollow moulded fibre product of the desired dimensions.

In some examples, the moulding system comprises a transferrer configured to move the hollow moulded fibre product precursor from the first mould to the second mould. In some examples, the transferrer is a mechanical transfer system. In some examples, the transferrer is configured to demould the hollow moulded fibre product precursor from the first mould and insert the hollow moulded fibre product precursor into the second mould.

In some examples, the first and second mould cavities are shaped to form necked bottles, and the first and second moulds each comprise a respective mould base wall at a first end of the respective mould body portion, and a mould neck wall at an opposite end of the respective mould body portion to the mould base wall. The first mould length and the second mould length extend longitudinally between the mould neck wall and the mould base wall of the respective mould. The first and second mould body portion walls may comprise a respective first or second mould main body wall and a first or second mould shoulder wall, the first or second mould shoulder wall between the respective first or second mould main body wall and first or second mould neck wall. The respective first or second mould cavity may be wider, or have a greater diameter, at the first or second mould main body wall than at the respective first or second mould neck wall. A width, or diameter, of the respective first or second mould cavity transitions between the width, or diameter, of the first or second mould main body wall and the width, or diameter, of the first or second mould neck wall along the first or second shoulder wall.

Optionally, the second mould length is at least 0.5% greater than the first mould length. This may provide sufficient clearance between the precursor body and the second mould to help avoid damage to the hollow moulded fibre product precursor during transfer to the second mould.

Optionally, the second mould length is no more than 5% greater than the first mould length. This may limit an amount of stretching of the precursor body required to form the hollow moulded fibre product from the hollow moulded fibre product precursor. Excessive stretching may detrimentally affect properties of the hollow moulded fibre product, such as strength, porosity and uniformity of wall thickness.

In some examples, the second mould length is no more than 3% greater than the first mould length. This may further limit stretching of the precursor body in the second mould compared with greater percentages.

Optionally, the second mould length is at least 0.5 mm greater than the first mould length. This may be a sufficient difference to help avoid damage to the hollow moulded fibre product precursor during transfer to the second mould.

Optionally, the second mould length is no more than 10 mm greater than the first mould length. This may limit an amount of stretching of the precursor body required to form the hollow moulded fibre product from the hollow moulded fibre product precursor. Excessive stretching may detrimentally affect properties of the hollow moulded fibre product, such as strength, porosity and uniformity of wall thickness.

In some examples, the second mould length is no more than 5 mm greater than the first mould length. This may further limit stretching of the precursor body in the second mould compared to greater values.

Optionally, the first mould comprises a first mould base wall extending, in the longitudinal direction, away from the first mould body portion wall by a first base distance that is less than a difference between the first mould length and the second mould length. Accordingly, the length of the precursor body and a precursor base is less than the second mould length, so that there is clearance between the precursor body and base and the second mould when the hollow moulded fibre product precursor is in the second mould cavity. In turn, this may reduce a chance of damage being caused to the precursor base during insertion of the hollow moulded fibre product precursor into the second mould and/or lessen the accumulation of fibres at a rim of mould parts of the second mould during insertion of the hollow moulded fibre product precursor into a mould part of the second mould.

In some examples, the first mould base wall is concave and thus configured to form a convex precursor base. Accordingly, if the precursor base were to contact the second mould as the hollow moulded fibre product precursor is inserted into the second mould, only an apex of the convex precursor base may contact the second mould base wall. In turn, this may reduce a chance of damage to the hollow moulded fibre product precursor being incurred during insertion into the second mould.

Optionally, the second mould comprises a second mould base wall comprising a punt-defining protrusion extending, in the longitudinal direction, towards the second mould body portion wall by a second base distance that is less than a difference between the first mould length and the second mould length. The second mould is thus configured to provide the hollow moulded fibre product with a punt, which can provide a stable hollow moulded fibre product when stood on its base.

Since the second base distance is less than a difference between the first mould length and the second mould length, clearance may be provided between the precursor base and the punt-defining protrusion during insertion of the hollow moulded fibre product precursor into the second mould. In turn, this may reduce a chance of damage to the hollow moulded fibre product precursor being incurred during insertion into the second mould.

Optionally, a sum of the first base distance and the second base distance is smaller than the difference between the first mould length and the second mould length. Clearance may thus be provided between the precursor and the second mould when the hollow moulded fibre product precursor is in the second mould cavity, which may further reduce a chance of damage to the hollow moulded fibre product precursor being incurred during insertion into the second mould.

Optionally, the second mould comprises a pair of mould parts separable from one another, wherein: when the second mould is placed in a closed position, in which the pair of mould parts abut one another along a split plane, the pair of mould parts define the second mould cavity therebetween; each mould part of the pair of mould parts has a second mould part body portion having the second mould length; and the second mould length is measured in a direction parallel to the split plane. During insertion and moulding of the hollow moulded fibre product precursor in the second mould, stray fibres extending from an outer surface of the hollow moulded fibre product precursor can become trapped between the pair of mould parts of the second mould. The pair of mould parts of the second mould may be held, or clamped, shut with a relatively large pressure, compared with moulds used for forming non-hollow moulded fibre products, such that the trapped fibres can damage contacting surfaces of the pair of mould parts. Since each mould part has a second mould part body portion having the second mould length, the chance of fibres accumulating on a rim of the mould part during insertion of the hollow moulded fibre product precursor (having the first body length, which is less than the second mould length) is lessened compared with inserting a hollow moulded fibre product precursor with a precursor body length equal to the second mould length into the mould part.

Optionally, the moulding system comprises an expandable member insertable into the hollow moulded fibre product precursor and configured, in use with the hollow moulded fibre product precursor in the second mould cavity, to expand in order to stretch the precursor body portion from the first body length to the second body length. Use of an expandable member, such as an inflatable bladder, may permit moulding of the hollow moulded fibre product precursor with relatively low risk of damage being caused to the hollow moulded fibre product precursor.

In examples in which the second mould comprises a pair of mould parts, the mould parts may be held together during moulding by the second mould with greater pressure than a pressure to which the expandable member is inflated. This may help to overcome pressure exerted against internal surfaces of the second mould during use of the second mould.

Mould parts of the second mould may be held together with a pressure of at least 15 bar. At such pressures, stray fibres that are trapped between the mould parts may damage contacting surfaces of the mould parts during moulding by the second mould. Accordingly, using the second mould to mould a hollow moulded fibre product precursor formed in the first mould may reduce a chance of damage to the contacting surfaces because the chance of stray fibres becoming trapped between the mould parts may be lessened.

In some examples, the second mould is configured to hold the mould parts together with a pressure of at least 20 bar.

In some examples, the second mould is a thermoforming mould.

Optionally, the first mould comprises a first mould neck wall, and the first mould body portion wall comprises a first mould main body wall and a first mould shoulder wall, the first mould shoulder wall between the first mould main body wall and the first mould neck wall; the second mould comprises a second mould neck wall, and the second mould body portion wall comprises a second mould main body wall and a second mould shoulder wall, the second mould shoulder wall between the second mould main body wall and the second mould neck wall; and the first mould shoulder wall has a first shoulder length, in the longitudinal direction, and the second mould shoulder wall has a second shoulder length, in the longitudinal direction, the second shoulder length smaller than the first shoulder length. Accordingly, clearance between a precursor shoulder and the second mould shoulder wall may be achieved when the hollow moulded fibre product precursor is in the second mould cavity. A chance of the hollow moulded fibre product precursor catching on the second mould shoulder wall during insertion into the second mould may thus be reduced compared to a moulding station in which the first shoulder length is equal to or smaller than the second shoulder length.

The first mould shoulder wall may have a first width proximal to the first mould main body wall, and a second width, smaller than the first width, proximal to the first mould neck wall. The second mould shoulder wall may have a third width proximal to the second mould main body wall, and a fourth width, smaller than the third width, proximal to the second mould neck wall. The first width may be equal to the third width. The second width may be equal to the fourth width.

In some examples, the first mould shoulder wall has a first average gradient, and the second mould shoulder wall has a second average gradient, wherein the second average gradient is smaller than the first average gradient. Again, this may create clearance between the precursor shoulder and the second mould shoulder wall when the hollow moulded fibre product precursor is in the second mould cavity. Accordingly, the chance of the hollow moulded fibre product precursor catching on the second mould shoulder wall during insertion into the second mould may be reduced compared with a moulding station in which the first average gradient is equal to or smaller than the second average gradient.

According to a second aspect of the present invention, there is provided a method of providing a hollow moulded fibre product, the method comprising: inserting a hollow moulded fibre product precursor into a mould cavity of a mould, the hollow moulded fibre product precursor comprising a precursor body having a first length along a longitudinal axis of the hollow moulded fibre product precursor, the mould comprising a mould body portion having a second length along a longitudinal axis of the mould cavity, the second length greater than the first length; and stretching the precursor body within the mould cavity, in a direction parallel to the longitudinal axis of the hollow moulded fibre product precursor and the longitudinal axis of the mould cavity, to increase a length of the precursor body from the first length to the second length to provide the hollow moulded fibre product.

Accordingly, the hollow moulded fibre precursor may be less likely to catch on or be damaged by the mould during insertion into the mould, as discussed above with respect to the first aspect.

In some examples, the method comprises forming the hollow moulded fibre product precursor in a precursor mould cavity of a precursor mould having a precursor mould body portion having the first length along a longitudinal axis of the precursor mould cavity, and transferring the hollow moulded fibre product precursor directly from the precursor mould to the mould. This may reduce the risk of damage to the hollow moulded fibre product precursor compared with a method in which additional steps are performed between demoulding of the hollow moulded fibre product precursor from the precursor mould and insertion into the mould.

Optionally, a difference between the first length and the second length is at least two times greater than an average fibre length of fibres forming the hollow moulded fibre product precursor. Fibres extending outwardly from an outer surface of the hollow moulded fibre product precursor may thus be less likely to catch on an edge of the mould as the hollow moulded fibre product precursor is inserted into the mould.

In some examples, the mould comprises a pair of mould parts that are separable from one another and, when the mould is in a closed position, the pair of mould parts abut one another along a split plane to define the mould cavity. In such examples, having a difference between the first length and the second length that is at least two times greater than an average fibre length of fibres forming the hollow moulded fibre product precursor may help to reduce a chance of fibres being trapped between the mould parts, which may damage contacting surfaces of the mould parts at relatively large pressures, for example above 15 bar.

Optionally, the method comprises inserting an expandable member into the hollow moulded fibre product precursor and, with the hollow moulded fibre product precursor in the mould cavity, expanding the expandable member to cause the stretching of the precursor body from the first length to the second length. Use of an expandable member, such as an inflatable bladder, may reduce a chance of damage being caused to the hollow moulded fibre product precursor during the stretching.

Optionally, a precursor base of the hollow moulded fibre product precursor is convex or flat, and the method comprises reshaping the precursor base to provide the hollow moulded fibre product with a concave base. Accordingly, clearance may be provided between the precursor base and a base of the mould so that the precursor base may be less likely to contact a base of the second mould during insertion of the hollow moulded fibre product precursor into the second mould, whilst attaining the desired shape of the hollow moulded fibre product during moulding in the mould.

Optionally, the precursor body portion comprises a precursor main body having a first main body length and a precursor shoulder having a first shoulder length, and wherein, a body portion of the hollow moulded fibre product comprises a main body having a second main body length greater than the first main body length, and a shoulder having a second shoulder length smaller than the first shoulder length, wherein a difference between the first main body length and the second main body length is greater than a difference between the first shoulder length and the second shoulder length. Accordingly, when the precursor is inserted into the mould cavity, there may be clearance between the precursor shoulder and the mould so that the hollow moulded fibre product precursor is less likely to be damaged during insertion into the mould, compared with a method in which the first shoulder length is equal to or smaller than the second shoulder length.

During the stretching, the precursor main body increases in length by an amount that is greater than an amount that the precursor shoulder decreases in length. Accordingly, there is a net gain in the length of the precursor body portion during the stretching.

In some examples, the precursor shoulder has a first average gradient, and the stretching comprises altering the first average gradient so that the shoulder of the hollow moulded fibre product has a second average gradient that is smaller than the first average gradient. The precursor shoulder may thus be less likely to contact the mould as the hollow moulded fibre product precursor is inserted into the mould, and thus less likely to be damaged, compared with the method not altering a length of the precursor shoulder.

According to a third aspect of the present invention, there is provided a control system configured to cause a moulding system to perform a method according to the second aspect. The moulding system may be a moulding system according to the first aspect.

According to a fourth aspect of the present invention, there is provided a non-transitory storage medium storing machine-readable instructions that, when executed by a processor of a control system, cause the processor to cause a moulding system to perform a method according to the second aspect.

In some examples of any of the above aspects, the hollow moulded fibre product is a necked hollow moulded fibre product, such as a bottle, a jar or a type of vase. In some examples of any of the above aspects, the hollow moulded fibre product is a bottle.

According to a fifth aspect of the present invention, there is provided a receptacle manufacturing line comprising a moulding system according to the first aspect, for providing the hollow moulded fibre product, and apparatus for performing at least one additional process on the hollow moulded fibre product to provide the receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase, and the receptacle manufacturing line is a necked-receptacle manufacturing line. In some examples, the receptacle is a bottle.

According to a sixth aspect of the present invention, there is provided a method of manufacturing a receptacle, the method comprising performing a method according to the second aspect to provide the hollow moulded fibre product, and then performing at least one additional process on the hollow moulded fibre product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

According to a seventh aspect of the present invention, there is provided a method of providing a content-containing receptacle, the method comprising providing a receptacle obtained by a method according to the sixth aspect, and providing contents in the receptacle to provide the content-containing receptacle.

In some examples, the providing contents in the receptacle comprises putting the contents into the receptacle. In contrast, in some examples, the providing the receptacle comprises providing the receptacle with the contents already present in the receptacle, thereby providing contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a necked receptacle, such as a bottle, a jar or a type of vase. In some examples, the receptacle is a bottle.

Optionally, the method comprises closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing contents in the receptacle (that is, the label or indicia is applied to the content-containing receptacle). In other examples, the applying the label or indicia to the receptacle occurs before or during the providing contents in the receptacle.

In some examples, the applying occurs before the closing. In some examples, the applying occurs after the closing. In some examples, the applying occurs during the closing.

According to an eighth aspect of the present invention, there is provided a receptacle obtained by a method according to the sixth aspect to contain contents.

The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any of those discussed above.

In some examples, the receptacle is a necked receptacle, such as a bottle, a jar or a type of vase. In some examples, the receptacle is a bottle.

According to a ninth aspect of the present invention, there is provided a receptacle obtainable or obtained from a fabrication method comprising the method of any one of the second, sixth or seventh aspects.

For example, the receptacle may be obtainable or obtained from the method of the second aspect of the present invention. The fabrication method may comprise at least one additional process. The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

Receptacles obtainable or obtained from such a fabrication method may be discernible from receptacles made by other methods; such receptables may comprise features indicative of the stretching of the precursor body that took place to provide the hollow moulded fibre product. Indicative features may comprise, for example, fibres that are aligned in the direction in which the precursor body was stretched, and/or fibres that are teased away from one another in the direction in which the precursor body was stretched, albeit to a degree that is acceptable given the intended function of the end product.

It will be appreciated that optional features of aspects of the present invention may be equally applied to other aspects of the present invention, where appropriate.

### BRIEF DESCRIPTION OF DRAWINGS

Embodiments of the invention will now be described, by way of example only, with reference to the accompanying drawings, in which:

FIG. 1 is a schematic view of an example receptacle manufacturing line for performing a method of manufacturing receptacles from paper pulp;

FIG. 2 is a schematic view of an example moulding system for providing a hollow moulded fibre product;

FIG. 3 is a cross-sectional view of a mould part of a first mould according to an example;

FIG. 4 is a cross-sectional view of a mould part of a second mould according to an example;

FIG. 5 is a side view of a hollow moulded fibre product precursor according to an example;

FIG. 6 is a side view of a hollow moulded fibre product according to an example;

FIG. 7 is a cross-sectional view of a second mould according to an example, with a hollow moulded fibre product precursor within a mould cavity of the second mould;

FIG. 8 shows a method of providing a hollow moulded fibre product according to an example;

FIG. 9 shows a non-transitory computer-readable storage medium according to an example;

FIG. 10 shows a schematic cross-sectional view of a receptacle containing contents, according to an example; and

FIG. 11 shows an example method of providing a content-containing receptacle.

### DETAILED DESCRIPTION

The following description presents exemplary embodiments and, together with the drawings, serves to explain principles of embodiments of the invention.

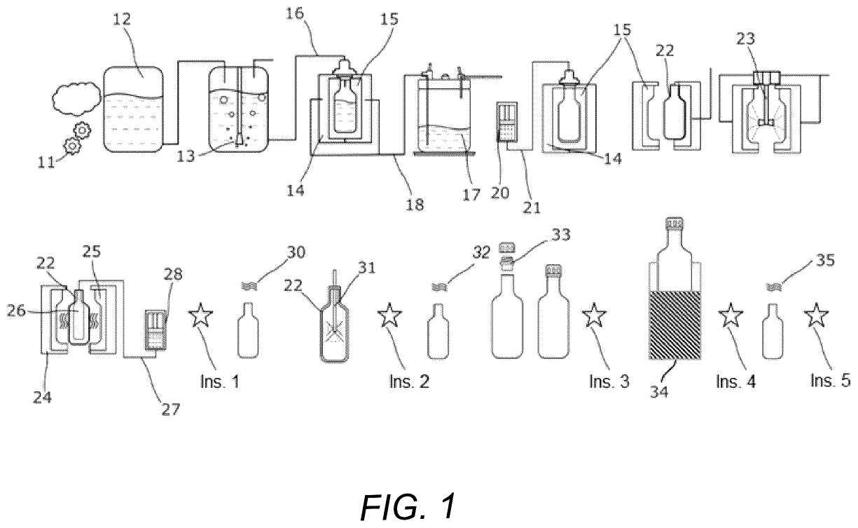

FIG. 1 shows a receptacle manufacturing line for performing a method of manufacturing receptacles, in this case necked receptacles, and more specifically in this case in the form of bottles, from paper pulp (i.e., which can form the basis of an example fibre suspension). By “necked receptacle” it is meant that the receptacle has an internal narrowing, or “neck”, between a main body portion, in which most of or all the contents of the receptacle are stored in use, and an opening through which the contents can enter or leave the receptacle in use. The internal width of the receptacle at the neck may be the same as or different to the internal width of the opening. However, the internal width of the neck is smaller than that of the main body portion, so that a shoulder is defined by and between the neck and the main body portion. This shoulder complicates manufacture of the receptacle, since it interferes with subsequent removal (and, in some cases, insertion) of whatever mould tool is inserted into the receptacle to form the internal shape of the receptacle. Examples of necked receptacles are bottles, jars, and certain types of vases. The process is merely exemplary and is provided to give context to examples of the present invention. It will be appreciated that, in other examples, the receptacle manufacturing line could be for making non-necked receptacles (i.e., receptacles without such a neck), such as bowls or trays.

Broadly speaking, the exemplary process comprises providing a fibre suspension, introducing the fibre suspension into a mould cavity of a porous first mould and expelling a liquid (such as water) from the fibre suspension to produce a hollow moulded fibre product (which may be called a wet precursor or embryo) in the mould cavity, further moulding the hollow moulded fibre product to produce a hollow further-moulded fibre product, drying and then internally-coating the hollow further-moulded fibre product to produce an internally coated product, drying the internally coated product to produce a dried product, applying a closure part to the dried product to produce a closable or closed product, externally-coating and/or decorating the closable or closed product to produce an externally coated and/or decorated product, and then drying the externally coated or decorated product to produce another dried product. As will be apparent at least from the following description, modifications may be made to the exemplary process to provide variants thereof in which other examples of the present invention may be embodied. For example, in some cases, either the internal coating or the external coating and/or decorating may be omitted. Moreover, in the present case and as indicated by the stars labelled Ins. 1 to Ins. 5 in FIG. 1, the process comprises inspecting or evaluating the hollow further-moulded fibre product, the internally coated product, the closable or closed product, the externally coated or decorated product, and the dried product to produce respective evaluated products. In some examples, the receptacle is the hollow moulded fibre product, the hollow further-moulded fibre product, the internally coated product, the closable or closed product, the externally coated or decorated product, one of the dried products, or one of the respective evaluated products.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (for example, the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (for example, a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), for example modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

Downstream of the vat 12 and the mixing station 13 is a first moulding station that comprises a porous first mould 15. In this example, the porous first mould 15 comprises two half-moulds 14 that are movable towards and away from each other, in this case using a hydraulic ram. In this example, each of the half-moulds 14 is a monolithic or unitary tool formed by additive manufacturing (for example, 3D-printing) that defines a mould profile, and, when the half-moulds 14 are brought into contact with each other, their respective mould profiles cooperate to define the mould cavity in which the hollow moulded fibre product is to be formed. Each half-mould 14 itself defines a smaller moulding cavity and, when brought into cooperation with a second half-mould 14, the smaller moulding cavities combine to provide the overall mould cavity. The two half-moulds 14 may themselves be considered “parts”, “splits” or “moulds” and the overall porous first mould 15 may be considered a “split-mould” or, again, a “mould”. In other examples, the porous first mould 15 may comprise more than two splits 14, such as three, four or six splits, that cooperate to define the moulding cavity.

In FIG. 1, the fibre suspension (also known as slurry) is top-filled into the porous first mould 15, in contrast to moulding processes that dip a mould in slurry. The fibre suspension is drawn under vacuum via a line 16 and into the porous first mould 15, with excess suspending liquid being drawn through the porous first mould 15 under vacuum via a line 18 into a tank 17. Shot mass may be controlled by measuring (for example, weighing) the amount of liquid drawn into the tank 17. A weight scale platform supporting the tank 17 is visible in FIG. 1. Once a required amount (for example, a predetermined volume, such as 10 litres, or a predetermined mass, such as 10 kilograms) of liquid has been collected in the tank 17, suction of the suspending liquid through the porous first mould 15 is stopped and the first mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous first mould 15 to form the hollow moulded fibre product.

In one example, in order to remove further suspending liquid (for example, water) from the hollow moulded fibre product, and form or consolidate the three-dimensional shape of the product, high pressure fluid (such as compressed air) is introduced into the first mould 15 to compress the fibre suspension against the cavity wall of the first mould 15. This process strengthens the product so that it can be handled, and displaces water from in between the fibres, thereby increasing the efficiency of a subsequent drying process. The fluid is regulated using a hydraulic pump 20. The pump 20 has a cylinder that displaces the fluid in a line 21 into the first mould 15. In an alternative example, an impermeable inflation element in the form of a collapsible bladder is inserted into the first mould 15 and expanded, by introduction of a fluid into the bladder from the line 21, to act as an internal high-pressure core structure for the first mould 15. In such an alternative, the fluid within the line 21 is preferably non-compressible, such as water or oil, although in other examples it could be a compressible fluid, such as air. Water has the advantage over other non-compressible liquids that any leaking or bursting of the bladder will not introduce a new substance to the system (since the suspending liquid is already water, or predominantly water).

Demoulding occurs when the first mould 15 opens for removal of the self-supporting hollow moulded fibre product 22. Mould cleaning 23 is preferably performed subsequently, to remove any remaining small fibres and/or other debris and maintain a porosity of the porous first mould 15. In this example, a radially firing high-pressure jet is inserted into the mould cavity while the first mould 15 is open. This dislodges debris from the wall of the mould cavity. Alternatively, or in addition, water from the tank 17 is pressurised through the back of the porous first mould 15 to dislodge entrapped fibres and/or other debris. Water is drained for recycling back to an upstream part of the system. It is noteworthy that cleaning is important for conditioning the first mould 15 for re-use. The first mould 15 may appear visibly clean after removal of the receptacle, but its performance could be compromised without cleaning.

According to FIG. 1, the hollow moulded fibre product 22 is subsequently transported to a second moulding station where, in a, for example, aluminium, mould 25, pressure and heat are applied for thermoforming a desired neck and surface finish, optionally including embossed and/or debossed surface features. After two halves of the mould 25 have closed around the product 22, a pressuriser is engaged. For example, a bladder 26 (for example, a thermoforming bladder 26) is inserted into the product 22. The bladder 26 is inflated with a pressurised fluid supplied via a line 27 by a pump 28. The pressurised fluid is preferably a non-compressible fluid such as water or oil, although in other examples it could be a compressible fluid such as air. In other examples, during supply, the pressurised fluid is heated with, for example, a heater or, alternatively, is cooled with, for example, a heat exchanger. An external mould block 24 of the mould 25, and/or the mould 25 itself, is also, or alternatively, heated in some examples. After thermoforming, a state of the product 22, which may now be considered a hollow further-moulded fibre product, is considerably more rigid, with more compressed side walls, as compared with the state of the product 22 at demoulding from the first mould 15.

A drying stage 30 (for example, a microwave drying process or other drying process) is performed on the product 22 downstream of the thermoforming, as shown, to provide a dried product. In one example, the drying stage 30 is performed before thermoforming to provide a dried product. However, moulding in the mould 25 requires some water content to assist with bonding during the compression process. The drying may be performed using a dryer, such as a machine that acts to cause drying of the product or simply a shelf or other support on which the product 22 rests while drying.

The product 22 is then subjected to an internal-coating stage during which, in this example, an interior coater in the form of a spray lance 31 is inserted into the product 22 and applies one or more surface coatings to internal walls of the product 22 to produce an internally coated product. In another example, the product 22 is instead filled with and subsequently drained of a liquid that coats the internal walls of the product 22. In practice, such coatings provide a protective layer to prevent egress of contents into the bottle wall, which may permeate and/or weaken it. Coatings will be selected dependent on the intended contents of finished receptacle, for example, a beverage, foodstuff, detergent, lubricant, pharmaceutical product, etc. In this example, the internally coated product 22 is then subjected to a curing or drying process 32, which can be configured or optimised dependent on the internal coating, for example, drying for twenty-four hours at ambient conditions or by a flash drying method. The drying again may be performed using a dryer, such as a machine that acts to cause drying of the product or simply a shelf or other support on which the product 22 rests while drying. Following the drying, the coated product 22 is considered another dried product.

A closure or mouth forming process is then performed on the product 22 by a closure-part applicator to produce a closable or closed product. For example, as shown in FIG. 1, a neck fitment 33 is affixed to the dried product. This results in the product being closable subsequently by positioning of a cap, lid or other closure relative to the neck fitment. An exterior coating and/or decoration is then applied to the product 22 by an exterior coater and/or a decorator, respectively, as shown in the further stage 34, to produce an externally coated and/or decorated product. In one example, the product 22 is dipped into a liquid to coat its outer surface, as shown in FIG. 1. In another example, the outer surface receives the external coating in a different manner. The coating and/or decoration may cover all or only part of an external surface of the product. The product 22 is then allowed to dry in warm air to produce another dried product. In other examples, the drying may be performed using a dryer such as one of those discussed above.

The product 22 may therefore be fully formed, considered the end “receptacle”, and ready to accept contents therein. In other examples, the receptacle may be fully formed without the neck fitment 35 being affixed and/or without the interior coating being applied and/or without the exterior coating being applied and/or without the decoration being applied and/or immediately after one of the drying processes or one of the inspecting and/or evaluating processes. For example, in some cases, the product is provided with the closure part by moulding the closure part during moulding of the product at the first moulding station and/or the second moulding station.

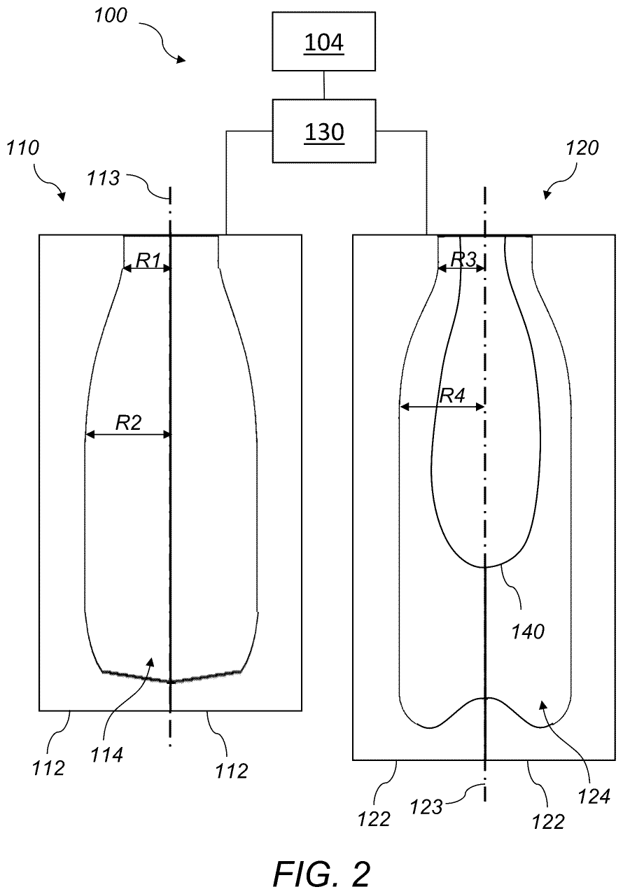

FIG. 2 shows a moulding system 100, according to an example, for providing a thermoformed hollow moulded fibre bottle 22b. The moulding system 100 comprises a primary mould 110, a thermoforming mould 120, a transfer mechanism 130, and an inflatable bladder 140 for use with the thermoforming mould 120. In FIG. 2, the primary mould 110 and the thermoforming mould 120 are shown in cross-section.

The primary 110 mould comprises a pair of primary mould parts 112 that are co-operable with each other along a primary part plane 113 to define a primary mould cavity 114. In some examples, the primary mould 110 is the mould 15 described with reference to FIG. 1. The thermoforming mould 120 comprises a pair of thermoforming mould parts 122 that are co-operable with each other along a thermoforming split plane 123 to define a thermoforming mould cavity 124. In some examples, the thermoforming mould 120 is the mould 25 described with reference to FIG. 1. In some examples, the inflatable bladder 140 is the thermoforming bladder 26 described with reference to FIG. 1.

The mould parts 112, 122 in each pair of mould parts are identical in shape to one another. Accordingly, each mould cavity 114, 124 is bisected by the respective split plane 113, 123. The pair of primary mould parts 112 are different in shape to the pair of thermoforming mould parts 122, so that a shape of the primary mould cavity 114 differs from a shape of the thermoforming mould cavity 124, as will be described in more detail herein.

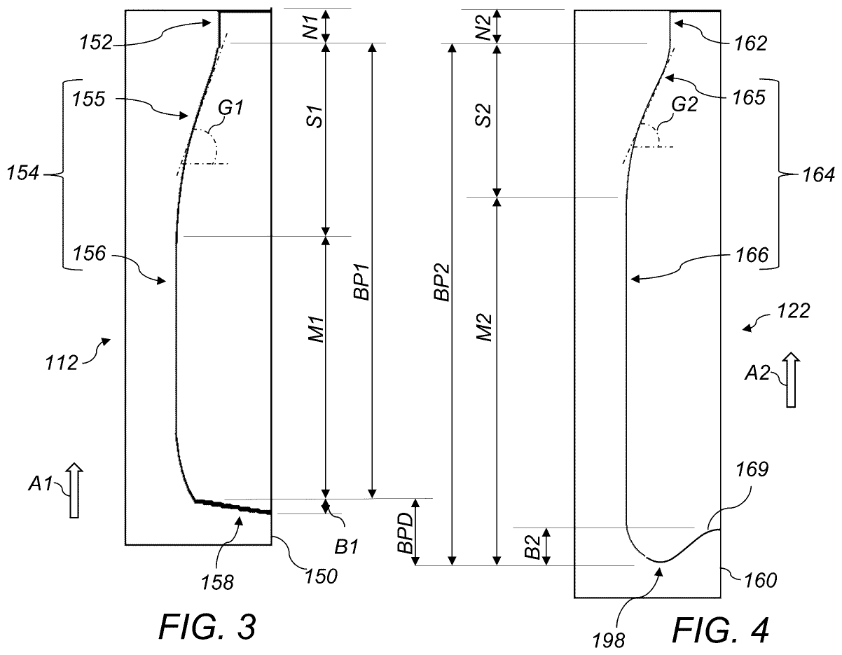

FIG. 3 is a cross-sectional side view of one of the primary mould parts 112. The primary mould part 112 has a split face 150 that abuts a split face 150 of the other primary mould part 112 along the primary split plane 113 when the pair of primary mould parts 112 cooperate with one another to form the primary mould cavity 114. The primary mould part 112 comprises a number of distinct sections, denoted herein as ‘primary’ portions to indicate that the portions are comprised in the primary mould part 112. The primary mould part 112 comprises a primary neck wall 152, a primary body portion wall 154 comprising a primary shoulder wall 155 and primary main body wall 156, and a primary base wall 158 which together define one half of the primary mould cavity 114. The primary body portion wall 154 is between the primary neck wall 152 and the primary base wall 158. The primary shoulder wall 155 is between the primary neck wall 152 and the primary main body wall 156. As shown in FIG. 2, proximal to the primary neck wall 152, the primary shoulder wall 155 has a first radius R1 equal to a maximum radius of the primary neck wall 152, and proximal to the primary main body wall 156, the primary shoulder wall 155 has a second radius R2 equal to a maximum radius of the primary main body wall 156, and which is greater than the first radius R1. The primary shoulder wall 155 has an average gradient G1 between the primary neck wall 152 and the primary main body wall 156.

The primary mould part 112 has a longitudinal direction, indicated by arrow A1 in FIG. 3, which is parallel to the primary split plane 113. As viewed parallel to the longitudinal direction A1, a cross-sectional profile of the one half of the primary mould cavity 114 is semi-circular along a length of the one half of the primary mould cavity 114. In the longitudinal direction A1, the primary neck wall 152 has a primary neck length N1, the primary shoulder wall 155 has a primary shoulder length S1 and the primary main body wall 156 has a primary main body length M1. Together, the primary shoulder length S1 and the main body length M1 form a primary body portion length BP1 of the primary body portion.

The primary base wall 158 has a positive draft angle, relative to the primary split plane 113, of around 2.5 degrees, which is exaggerated in FIGS. 2 and 3 for clarity. Accordingly, the primary base wall 158 extends away, in the longitudinal direction A1, from an end of the primary main body wall 156 that is opposite to an end of the primary main body wall 156 proximal to the primary shoulder wall 155, by a primary base distance B1.

FIG. 4 is a cross-sectional side view of one of the thermoforming mould parts 122. The thermoforming mould part 122 has a split face 160 that abuts a split face 160 of the other thermoforming mould part 122 along the thermoforming split plane 123 when the pair of thermoforming mould parts 122 cooperate with one another to form the thermoforming mould cavity 124. The thermoforming mould part 122 comprises a thermoforming neck wall 162, a thermoforming body portion wall 164 comprising a thermoforming shoulder wall 165 and thermoforming main body wall 166, and a thermoforming base wall 168 which together define one half of the thermoforming mould cavity 114. The thermoforming body portion wall 164 is between the thermoforming neck wall 162 and the thermoforming base wall 168. The thermoforming shoulder wall 165 is between the thermoforming neck wall 162 and the thermoforming main body wall 166. As shown in FIG. 2, proximal to the thermoforming neck wall 162, the thermoforming shoulder wall 165 has a third radius R3 equal to a maximum radius of the thermoforming neck wall 162, and proximal to the thermoforming main body wall 166, the thermoforming shoulder wall 165 has a fourth radius R4 equal to a maximum radius of the thermoforming main body wall 166, and which is greater than the third radius R3. In this example, the third radius R3 is equal to the first radius R1, and the fourth radius R4 is equal to the second radius R2. The thermoforming shoulder wall 165 has an average gradient G2 between the thermoforming neck wall 162 and the thermoforming main body wall 166. The average gradient G2 of the thermoforming shoulder wall 165 is smaller than the average gradient G1 of the primary shoulder wall 155.

The thermoforming mould part 122 has a longitudinal direction, indicated by arrow A2 in FIG. 3, which is parallel to the thermoforming split plane 123. As viewed parallel to the longitudinal direction A2, a cross-sectional profile of the one half of the thermoforming mould cavity 124 is semi-circular along a length of the one half of the thermoforming mould cavity 124. In the longitudinal direction A2, the thermoforming neck wall 162 has a thermoforming neck length N2, the thermoforming shoulder wall 165 has a thermoforming shoulder length S2 and the thermoforming main body wall 166 has a main body length M2. Together, the thermoforming shoulder length S2 and the main body length M2 form a thermoforming body portion length BP2 of the thermoforming body portion wall 164.

The primary neck length N1 is substantially equal to the thermoforming neck length N2. The primary main body portion length BP1 is less than the thermoforming main body portion length BP2 by a body portion length difference BPD. In this example, the body portion length difference BPD is exaggerated in FIGS. 2, 3 and 5, for clarity, but in practice is around 7 mm. In other examples other distances are envisaged, for example distances in which the thermoforming main body portion length BP2 is at least 0.5% and no greater than 5% greater than the primary main body portion length BP1. The primary shoulder length S1 is greater than the thermoforming shoulder length S2 by around 5 mm, and the primary main body length M1 is less than the thermoforming main body length M2 by around 12 mm. The difference between the primary main body length M1 and the thermoforming main body length M2 is greater than the difference between the primary shoulder length S1 and the thermoforming shoulder length S2. The primary base distance B1 is less than the body portion length difference BPD, and in this example is around 2 mm.

The thermoforming base wall 168 has a punt-defining portion 169, which is exaggerated in FIGS. 2, 4 and 7 for clarity. The punt-defining portion 169 extends, in the longitudinal direction A2, towards the thermoforming mould body portion 164 by a thermoforming base distance B2, which is less than the body portion length difference BPD, and in this example is around 3 mm. The sum of the primary base distance B1 and the thermoforming base distance B2 is less than the body portion length difference BPD

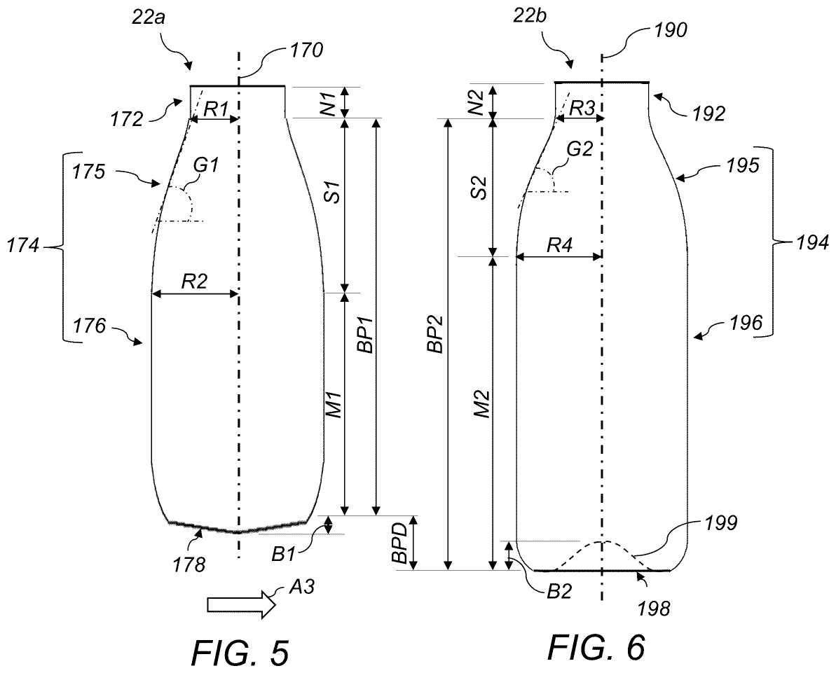

The primary mould 110 and the thermoforming mould 120 are configured for use in a manufacturing line configured to form a necked-receptacle, in this example a bottle. The manufacturing line may be the receptacle manufacturing line described with reference to FIG. 1. The primary mould 110 is configured to form a hollow moulded fibre bottle precursor 22a (referred to herein as the precursor 22a), and the thermoforming mould 120 is configured to form a thermoformed hollow moulded fibre bottle 22b (referred to herein as the bottle 22b), as best shown in FIGS. 5 and 6 respectively, and described in more detail hereinafter.

In use of the moulding system 100, with the pair of primary mould parts 112 cooperating with each other to define the primary mould cavity 114, a fibre slurry is supplied to the primary mould cavity 114. In use of the primary mould 110, water (optionally containing additives) from the fibre slurry is drawn from the mould cavity 114 via dewatering apertures (not shown). The fibre slurry is moulded by the primary mould 110 to the shape of the primary mould cavity 114 to provide the precursor 22a (illustrated in side view in FIG. 5).

The precursor 22a corresponds in shape to the primary mould cavity 114. The precursor 22a is thus generally cylindrical, with a central longitudinal axis 170. The precursor 22a has: a precursor neck 172, a precursor body portion 174 comprising a precursor shoulder 175 and precursor main body 176, and a precursor base 178. The precursor body portion 174 is between the precursor neck 172 and the precursor base 178. The precursor shoulder 175 is between the precursor neck 172 and the precursor main body 176. As shown in FIG. 5, proximal to the precursor neck 172, the precursor shoulder 175 has the first radius R1, and proximal to the precursor main body 176, the precursor shoulder 175 has the second radius R2. The precursor shoulder 175 has an average gradient G1 between the precursor neck 172 and the precursor main body 176 equal to the average gradient G1 of the primary shoulder wall 155.

Parallel to the central longitudinal axis 170, the precursor neck 172 has the primary neck length N1, the precursor shoulder 175 has the primary shoulder length S1 and the precursor main body 176 has the primary main body length M1, so that the precursor body portion 174 has the precursor body portion length BP1.

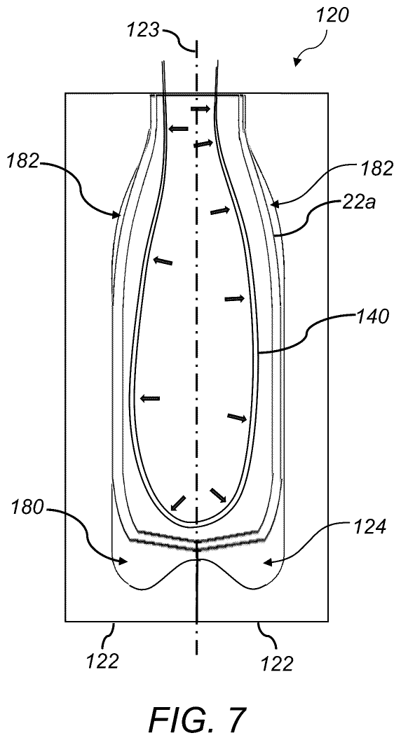

As a result of the positive draft angle of the primary base wall 158 of the pair of primary mould parts 112, the precursor base 178 has the positive draft angle, which is exaggerated in FIGS. 5 and 7 for clarity. In this example, the precursor base portion 178 is convex. Accordingly, the precursor base 178 extends away, in a direction parallel to the central longitudinal axis 170, from an end of the precursor main body 176 that is opposite to an end of the precursor main body 176 proximal to the precursor shoulder 175, by the primary base distance B1.

Returning to use of the moulding system 100, the primary mould parts 112 are separated from one another to permit demoulding of the precursor 22a from the primary mould 110. The precursor 22a is demoulded from the primary mould parts 112 in a direction that is normal to the primary split plane 113, see arrow A3 in FIG. 5.

The transfer mechanism 130 is configured to transfer the precursor 22a from the primary mould 110 to one of the thermoforming mould parts 122. The thermoforming mould parts 122 are subsequently moved together so that the precursor 22a is in the thermoforming mould cavity 124, as best shown in FIG. 7, which is a cross-sectional view of the thermoforming mould 120, with the precursor 22a in the thermoforming mould cavity 124, and the inflatable bladder 140 inserted into the precursor 22a and in a partially inflated configuration.

Due to the difference in shape between the primary mould cavity 114 and the thermoforming mould cavity 124, a first void 180 is formed between the precursor base 178 and the thermoforming base wall 168, and a second void 182, which is annular, is formed between the precursor shoulder 175 and the thermoforming shoulder wall 165. Such clearance between an outer surface of the precursor 22a and the thermoforming mould 120 can help prevent fibres extending outwardly from the outer surface of the precursor 22a from catching on a thermoforming mould part 122 as the precursor 22a is inserted into the thermoforming mould 120, and from being trapped between the abutting surfaces 160 of the pair of thermoforming mould parts 122.

With the thermoforming mould parts 122 held together with a pressure of around 19.5 bar, the inflatable bladder 140 is inserted into the precursor 22a and inflated to a pressure of around 17 bar, as denoted by the arrows in FIG. 7. The precursor 22a is urged against the thermoforming mould 120 by the inflatable bladder 140, when inflated, to substantially eradicate the first and second voids 180, 182, thus forming the bottle 22b. The precursor main body 156 is stretched, in a direction parallel to the central longitudinal axis 170, to the thermoforming main body length M2. The precursor shoulder 155 reduces in length, in a direction parallel to the central longitudinal axis 170, to the thermoforming shoulder length S2, and the average gradient G1 of the precursor shoulder 155 is changed to the average gradient G2 of the thermoforming shoulder wall 165. The precursor neck wall 152 is not stretched in the thermoforming mould 120.

FIG. 6 shows a side view of the bottle 22b after being moulded by the thermoforming mould 120. The bottle 22b corresponds in shape to the thermoforming mould cavity 124. The bottle 22b is thus generally cylindrical, with a central longitudinal axis 190. The bottle 22b has: a bottle neck 192, a bottle body portion 194 comprising a bottle shoulder 195 and bottle main body 196, and a bottle base 198. The bottle body portion 194 is between the bottle neck 192 and the bottle base 198. The bottle shoulder 195 is between the bottle neck 192 and the bottle main body 196. As shown in FIG. 6, proximal to the bottle neck 192, the bottle shoulder 195 has the third radius R3, and proximal to the bottle main body 196, the bottle shoulder 195 has the fourth radius R4. The bottle shoulder 195 has an average gradient G2 between the bottle neck 192 and the bottle main body 196, which is equal to the average gradient G2 of the thermoforming shoulder wall 165.

Parallel to the central longitudinal axis 190, the bottle neck 192 has the thermoforming neck length N2, the bottle shoulder 195 has the thermoforming shoulder length S2 and the bottle main body 196 has the thermoforming main body length M2, so that the bottle body portion 194 has the thermoforming body portion length BP2.

As a result of the punt-defining portion 169 of the thermoforming base wall 168 of the pair of thermoforming mould parts 122, the precursor base 178 is reshaped in the thermoforming mould 120 so that the bottle 22b has a bottle base 198 with a punt 199, which is shown in dashed lines and exaggerated in FIG. 6, for clarity. Accordingly, the bottle base 198 extends towards the bottle body portion 194, in a direction parallel to the central longitudinal axis 190, by the thermoforming base distance B2.

It will be appreciated that there is provided a control system 104 that is configured to cause the moulding system 100 to: supply a fibre slurry to the primary mould cavity 114, and mould, using the primary mould 110, the fibre slurry in the primary mould cavity 114 to provide the precursor 22a, the precursor 22a having a precursor body portion 174 having the primary body portion length BP1; transfer the precursor 22a to the thermoforming mould cavity 124; and increase the length of the precursor body portion 174 to the thermoforming body portion length BP2 to provide the bottle 22b.

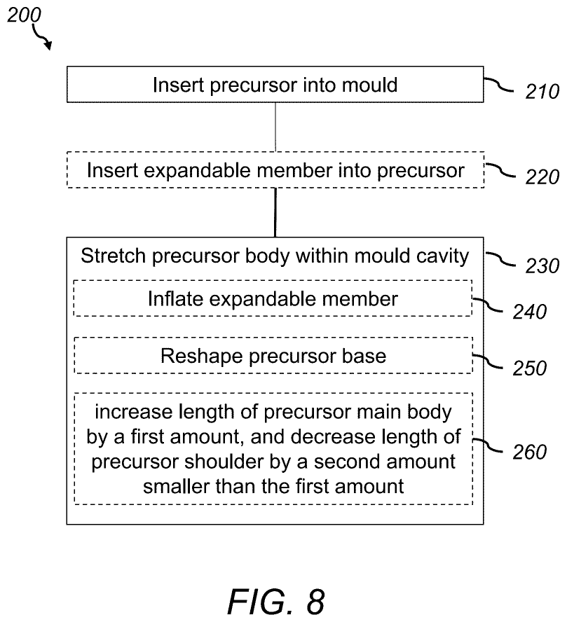

FIG. 8 shows a method 200 of providing a hollow moulded fibre product. The method 200 may be known as a fabrication method, in some examples. The hollow moulded fibre product may be the bottle 22b provided by the moulding system 100 described above with reference to FIGS. 2-4 and 7. The method 200 comprises inserting a hollow moulded fibre product precursor into a mould cavity of a mould, as denoted by block 210. The hollow moulded fibre product precursor may be the precursor 22a described with reference to FIG. 6. The hollow moulded fibre product precursor has a precursor body having a first length along a longitudinal axis of the hollow moulded fibre product precursor, and the mould comprises a mould body portion wall having a second length along a longitudinal axis of the mould cavity, the second length greater than the first length. In this example, the difference between the first length and the second length is three times greater than an average fibre length of fibres forming the hollow moulded fibre product precursor.

The method 200 comprises inserting an expandable member, in this example an inflatable bladder, into the hollow moulded fibre product precursor, as denoted by block 220, and stretching the precursor body within the mould cavity, in a direction parallel to the longitudinal axis of the hollow moulded fibre product precursor and the longitudinal axis of the mould cavity, as denoted by block 230. In this example, the stretching comprises inflating the inflatable bladder to cause the stretching of the precursor body from the first length to the second length, as denoted by block 240. The method comprises holding mould parts of the mould together with a pressure that is greater than a pressure to which the inflatable bladder is inflated. In this example, the mould parts are held together with a pressure of around 19.5 bar, and the inflatable bladder is inflated to a pressure of around 17 bar.

In this example, the hollow moulded fibre product precursor has a precursor base that is convex or flat, and the mould has a punt-defining portion comprised in a base wall of the mould. The stretching comprises reshaping the precursor base, as denoted by block 250, so that the hollow moulded fibre product has a base that is concave, or comprises a punt. In other examples, the mould has a flat base, and the method comprises reshaping the convex precursor base so that the base of the hollow moulded fibre product is flat.

In this example, the precursor body portion comprises a precursor main body and a precursor shoulder. The stretching comprises increasing a length of the precursor main body by a first amount, and decreasing a length of the precursor shoulder by a second amount, the first amount greater than the second amount, as denoted by block 260. A body portion of the hollow moulded fibre product comprises a main body having a second main body length greater than the first main body length, and a shoulder having a second shoulder length smaller than the first shoulder length, wherein a difference between the first main body length and the second main body length is greater than a difference between the first shoulder length and the second shoulder length.

The method 200 therefore forms a receptacle. For example, FIG. 10 depicts a receptacle 900 that is obtained from the fabrication method.

In other examples of the method 200, one or more parts may be omitted, as denoted by the dashed blocks in FIG. 8.

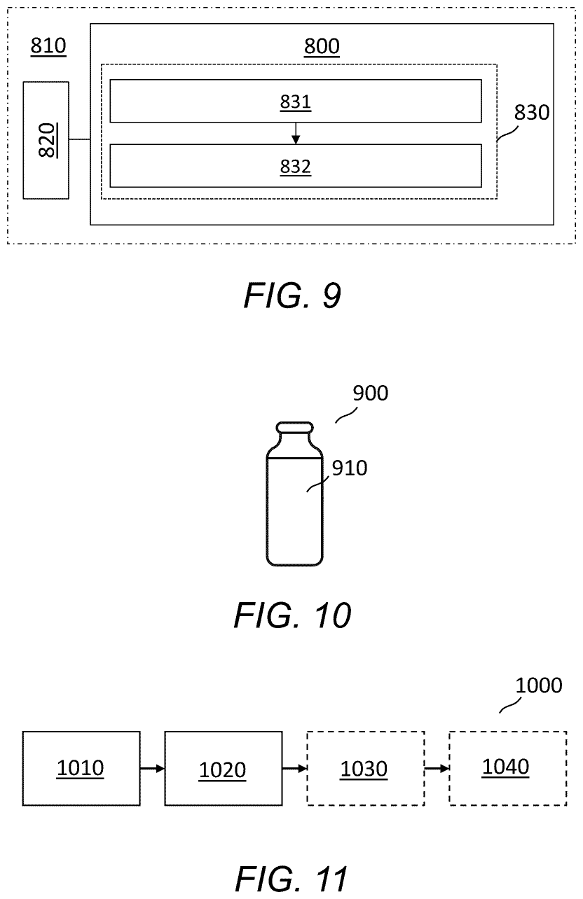

FIG. 9 shows a schematic diagram of a non-transitory computer-readable storage medium 800 according to an example. The non-transitory computer-readable storage medium 800 stores instructions 830 that, if executed by a processor 820 of a control system 810 of a moulding system, cause the moulding system to perform a method according to an example, such as the method 200 described with reference to FIG. 8. In some examples, the control system 810 is or comprises the control system 104 as described above. The instructions 830 comprise: causing a transfer mechanism of the moulding system to insert a hollow moulded fibre product precursor into a mould cavity of a mould, the hollow moulded fibre product precursor comprising a precursor body having a first length along a longitudinal axis of the hollow moulded fibre product precursor, the mould comprising a mould body portion wall having a second length along a longitudinal axis of the mould cavity, the second length greater than the first length; and to stretch the precursor body portion within the mould cavity, in a direction parallel to the longitudinal axis of the hollow moulded fibre product precursor and the longitudinal axis of the mould cavity, to increase a length of the precursor body from the first length to the second length to provide the hollow moulded fibre product. In other examples, the instructions 830 comprise instructions to cause the moulding system to perform any other example methods described herein.

It will also be appreciated that there also is provided a receptacle manufacturing line (such as that shown in FIG. 1) comprising a moulding system, such as the moulding system 100 described herein, for providing a hollow moulded fibre product and apparatus for performing at least one additional process on the hollow moulded fibre product to provide the receptacle. Similarly, also provided is a method of manufacturing a receptacle, the method comprising inserting a hollow moulded fibre product precursor into a mould cavity of a mould, the hollow moulded fibre product precursor comprising a precursor body having a first length along a longitudinal axis of the hollow moulded fibre product precursor, the mould comprising a mould body portion wall having a second length along a longitudinal axis of the mould cavity, the second length greater than the first length; and stretching the precursor body within the mould cavity, in a direction parallel to the longitudinal axis of the hollow moulded fibre product precursor and the longitudinal axis of the mould cavity, to increase a length of the precursor body from the first length to the second length to provide the hollow moulded fibre product, and then performing at least one additional process on the hollow moulded fibre product to provide the receptacle. Examples of the “at least one additional process” are described above with reference to FIG. 1.

Also provided, as a result of the content of the present application, is use of a receptacle obtained by any of the methods described herein to contain contents. An example such receptacle 900, in the form of a necked receptacle and specifically a bottle, containing contents 910 is shown in FIG. 10. The use could be, for example, by a person who puts the contents into the receptacle, by a person who transports the contents, or by a person who wishes to dispose of (for example, to a consumer or end user), offer to dispose of (for example, to a consumer or end user), import, or keep the contents whether for disposal or otherwise. The contents could, for example, be any one or more of the example contents described herein.

Also provided is a method of providing a content-containing receptacle. An example such method 1000 is shown in FIG. 11. The method 1000 comprises providing 1010 the receptacle, in the form of a necked receptacle and specifically a bottle, and then providing 1020 the contents in the receptacle. In this example, block 1020 follows block 1010, so that block 1020 comprises putting the contents into the receptacle that has been provided at block 1010. However, in some other examples, blocks 1010 and 1020 are performed concurrently, so that the providing 1010 the receptacle comprises providing the receptacle with the contents already present in the receptacle. The contents could, for example, be any one or more of the example contents described herein. The method 1000 also comprises closing 1030 an opening of the receptacle after block 1020, and applying 1040 a label or indicia to the receptacle after block 1030. In this example, block 1030 involves applying a heat seal to the opening and then screwing a cap or lid onto the receptacle, and block 1040 comprises adhering a label onto the receptacle.

In respective other examples, the order of blocks 1030 and 1040 is reversed, blocks 1030 and 1040 are performed concurrently, block 1030 is omitted, and block 1040 is omitted. In some examples, block 1040 occurs before block 1020, or block 1040 occurs during block 1020. For example, in some cases, the label or indicia is applied to the receptacle, then the contents are provided in the receptacle, and then the receptacle is closed.

It will be appreciated that the method 1000 could be performed by the same party that manufactures the receptacle, for example so that block 1010 comprises the method discussed above with reference to the manufacturing line shown in FIG. 1. Alternatively, the method 1000 could be performed by a different party to that which manufactures the receptacle. In such an alternative, the different party performs block 1010 by way of obtaining the receptacle from the party that manufactures the receptacle (such as by way of the method discussed above with reference to FIG. 1) or from an intermediary.

Example embodiments of the present invention have been discussed, with reference to the examples illustrated. However, it will be appreciated that variations and modifications may be made without departing from the scope of the invention as defined by the appended claims.

What is claimed is:

1. A moulding system for providing a hollow moulded fibre product, the moulding system comprising:
a first mould defining a first mould cavity and having a first mould body portion wall having a first mould length, the first mould configured to provide a hollow moulded fibre product precursor having a precursor body having a first body length in a longitudinal direction of the hollow moulded fibre product precursor; and
a second mould defining a second mould cavity and having a second mould body portion wall having a second mould length greater than the first mould length, the second mould configured to provide the hollow moulded fibre product;
wherein the moulding system is configured, with the hollow moulded fibre product precursor in the second mould cavity, to stretch the precursor body of the hollow moulded fibre product precursor from the first body length to a second body length, the second body length equal to the second mould length, to thereby provide the hollow moulded fibre product from the hollow moulded fibre product precursor.

2. The moulding system of claim 1, wherein the second mould length is at least 0.5% greater than the first mould length.

3. The moulding system of claim 1, wherein the second mould length is no more than 5% greater than the first mould length.

4. The moulding system of claim 1, wherein the second mould length is at least 0.5 mm greater than the first mould length.

5. The moulding system of claim 1, wherein the second mould length is no more than 10 mm greater than the first mould length.

6. The moulding system of claim 1, wherein the first mould comprises a first mould base wall extending, in the longitudinal direction, away from the first mould body portion wall by a first base distance that is less than a difference between the first mould length and the second mould length.

7. The moulding system of claim 1, wherein the second mould comprises a second mould base wall comprising a punt-defining protrusion extending, in the longitudinal direction, towards the second mould body portion wall by a second base distance that is less than a difference between the first mould length and the second mould length.

8. The moulding system of claim 1, wherein the second mould comprises a pair of mould parts separable from one another, wherein:
when the second mould is placed in a closed position, in which the pair of mould parts abut one another along a split plane, the pair of mould parts define the second mould cavity therebetween;
each mould part of the pair of mould parts has a second mould part body portion wall having the second mould length; and
the second mould length is measured in a direction parallel to the split plane.

9. The moulding system of claim 1, comprising an expandable member insertable into the hollow moulded fibre product precursor and configured, in use with the hollow moulded fibre product precursor in the second mould cavity, to expand in order to stretch the precursor body portion from the first body length to the second body length.

10. The moulding system of claim 1, wherein:
the first mould comprises a first mould neck wall, and the first mould body portion wall comprises a first mould main body wall and a first mould shoulder wall, the first mould shoulder wall between the first mould main body wall and the first mould neck wall;
the second mould comprises a second mould neck wall, and the second mould body portion wall comprises a second mould main body wall and a second mould shoulder wall, the second mould shoulder wall between the second mould main body wall and the second mould neck wall; and
the first mould shoulder wall has a first shoulder length, in the longitudinal direction, and the second mould shoulder wall has a second shoulder length, in the longitudinal direction, the second shoulder length smaller than the first shoulder length.

11. A method of providing a hollow moulded fibre product, the method comprising:
inserting a hollow moulded fibre product precursor into a mould cavity of a mould, the hollow moulded fibre product precursor comprising a precursor body having a first length along a longitudinal axis of the hollow moulded fibre product precursor, the mould comprising a mould body portion wall having a second length along a longitudinal axis of the mould cavity, the second length greater than the first length; and
stretching the precursor body within the mould cavity, in a direction parallel to the longitudinal axis of the hollow moulded fibre product precursor and the longitudinal axis of the mould cavity, to increase a length of the precursor body from the first length to the second length to provide the hollow moulded fibre product.

12. The method of claim 11, wherein a difference between the first length and the second length is at least two times greater than an average fibre length of fibres forming the hollow moulded fibre product precursor.

13. The method of claim 11, comprising inserting an expandable member into the hollow moulded fibre product precursor and, with the hollow moulded fibre product precursor in the mould cavity, expanding the expandable member to cause the stretching of the precursor body from the first length to the second length.

14. The method of claim 11, wherein a precursor base of the hollow moulded fibre product precursor is convex or flat, and the method comprises reshaping the precursor base to provide the hollow moulded fibre product with a concave base.

15. The method of claim 11, wherein the precursor body portion comprises a precursor main body having a first main body length and a precursor shoulder having a first shoulder length, and wherein, a body portion of the hollow moulded fibre product comprises a main body having a second main body length greater than the first main body length, and a shoulder having a second shoulder length smaller than the first shoulder length, wherein a difference between the first main body length and the second main body length is greater than a difference between the first shoulder length and the second shoulder length.

16. A control system configured to cause a moulding system to perform the method of claim 11.

17. A non-transitory storage medium storing machine-readable instructions that, when executed by a processor of a control system, cause the processor to cause a moulding system to perform the method of claim 11.

18. A receptacle manufacturing line comprising the moulding system of claim 1 for providing the hollow moulded fibre product, and apparatus for performing at least one additional process on the hollow moulded fibre product to provide the receptacle.

19. A receptacle produced by the process comprising:
providing a hollow moulded fibre product;
inserting a hollow moulded fibre product precursor into a mould cavity of a mould, the hollow moulded fibre product precursor comprising a precursor body having a first length along a longitudinal axis of the hollow moulded fibre product precursor, the mould comprising a mould body portion wall having a second length along a longitudinal axis of the mould cavity, the second length greater than the first length; and
stretching the precursor body within the mould cavity, in a direction parallel to the longitudinal axis of the hollow moulded fibre product precursor and the longitudinal axis of the mould cavity, to increase a length of the precursor body from the first length to the second length to provide the hollow moulded fibre product.
